(19) United States
(12) Patent Application Publication
(10) Pub. No.: US 2005/0179533 A1
(43) Pub. Date: Aug. 18, 2005

(54) Automobile u-turn signal

(76) Inventor: Darla J. Stevenson, Rancho Palos Verdes, CA (US)

Correspondence Address: DARLA J. STEVENSON, 224 Oak Glen, Irvine, CA, 92618, US

(21) Appl. No.: 10/699,413

(22) Filed: Feb. 18, 2004

(51) Int. Cl. B60Q 1/34

(52) U.S. Cl. 340/475

(57) ABSTRACT

The u-turn signal is clearly shown at the rear left and the front left of the automobile. No longer will one have to distinguish between someone turning left versus someone making a u-turn at a slower rate of speed.

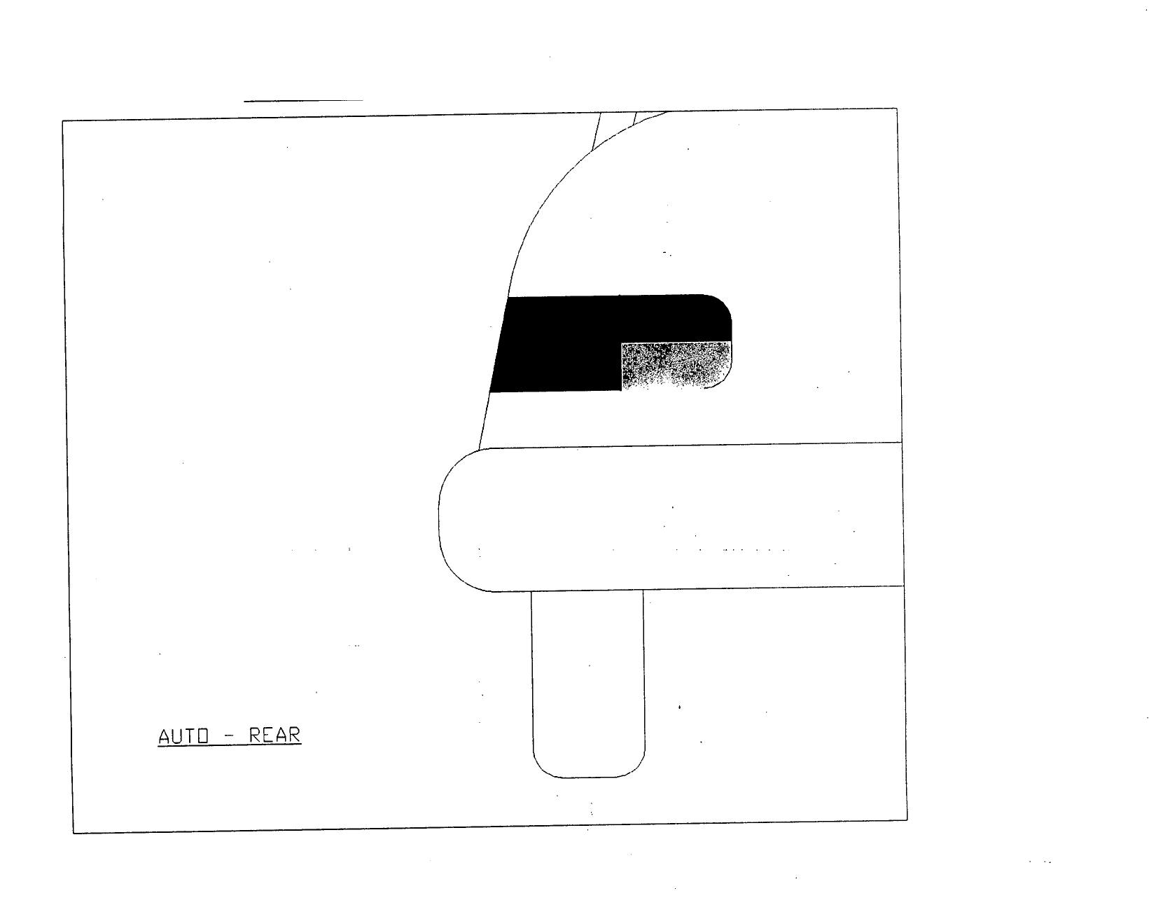

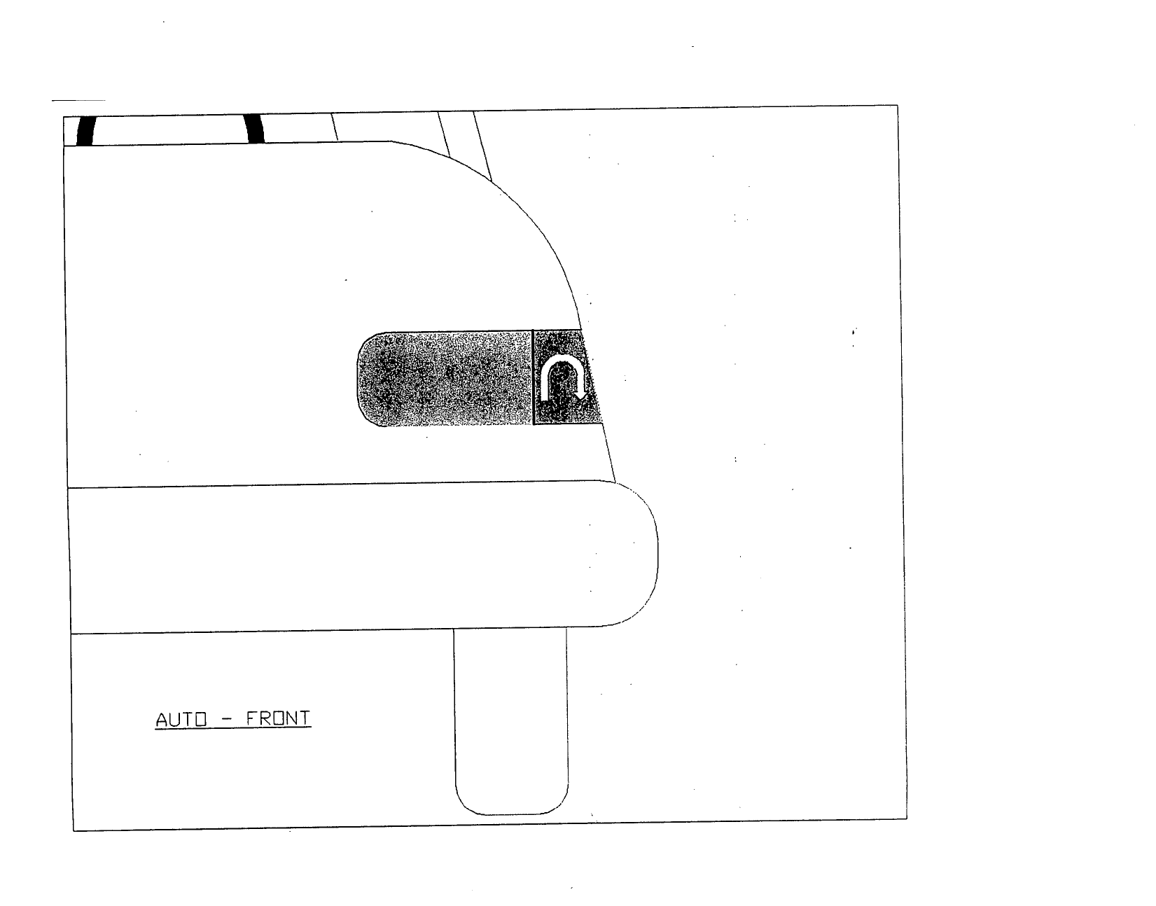

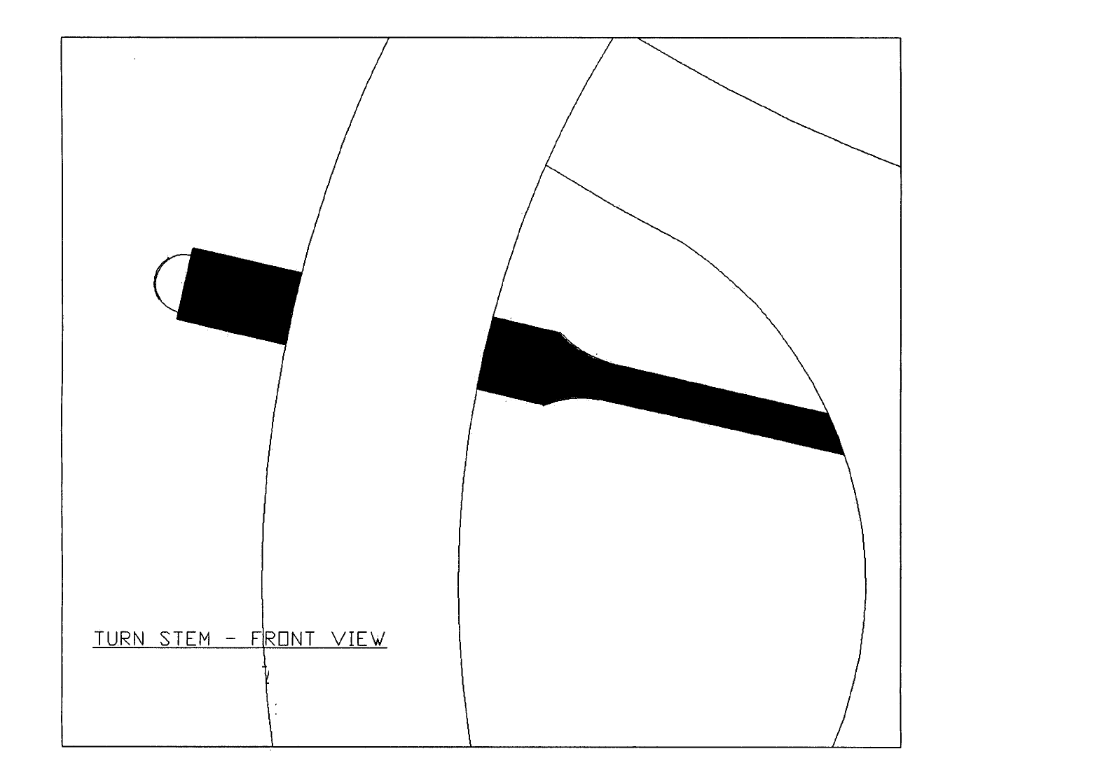

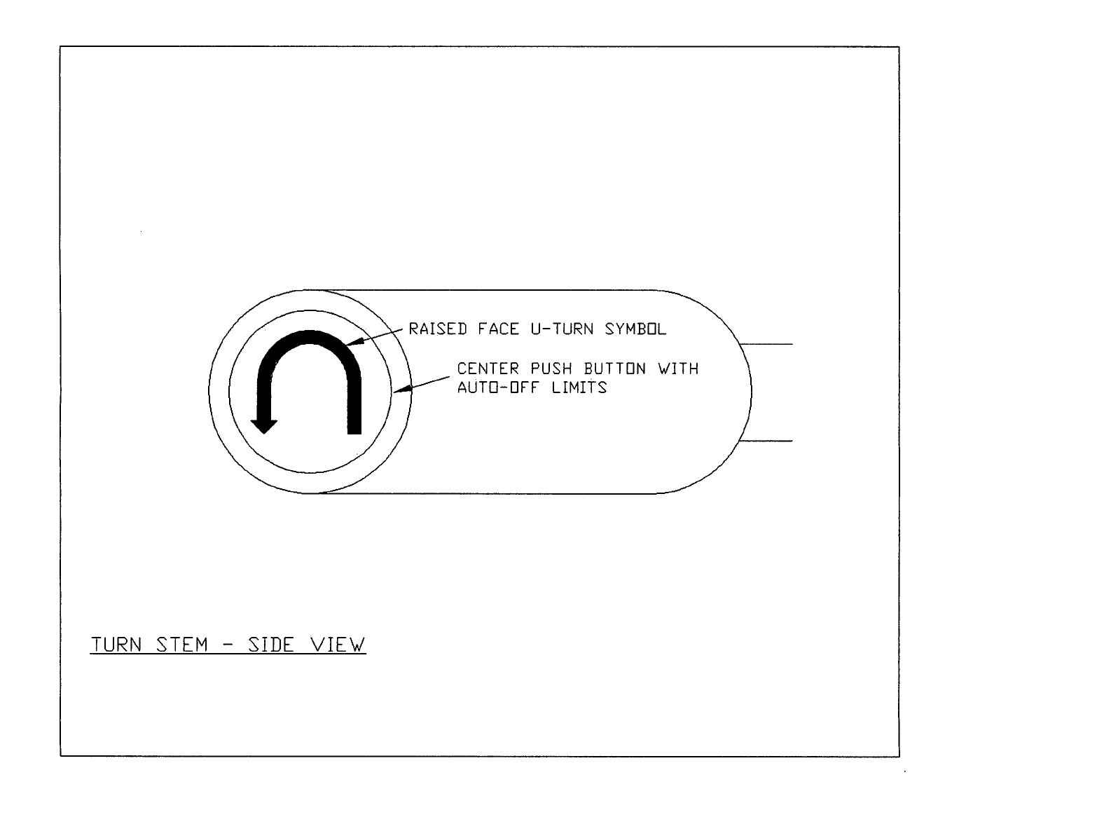

### CROSS-REFERENCE TO RELATED APPLICATIONS

Disclosure Document No. 535250

### REGARDING FEDERALLY SPONSORED RESEARCH OR DEVELOPMENT

Not Applicable

### TO SEQUENCE LISTING, A TABLE, OR A COMPUTER PROGRAM LISTING COMPACT DISC APPENDIX

Not Applicable

### BACKGROUND OF THE INVENTION

The automobile U-Turn Signal is my idea derived from times I have been trying to u-turn the person behind me has accelerated to left turn, nearly running into my automobile, not knowing I am slowing in order to u-turn, not left turn. When using a left-turn signal to u-turn, the impression is given one is turning left and not giving any signal is just as confusing for cars behind or oncoming.

As a result of this product, not only will rear-end collisions be lessened, but also various other collisions will diminish when oncoming traffic and traffic in lanes to the left of the driver no longer misunderstand the driver's intention to u-turn.

### BRIEF SUMMARY OF THE INVENTION

The u-turn signal is clearly shown as a u-turn signal at the rear left and front left of the automobile thus distinguishing it from an ordinary left and right arrow turn signal.

### DETAILED DESCRIPTION OF THE INVENTION

The u-turn signal is clearly shown as a u-turn signal at the rear left and on the front left of the automobile not as a blinking left or right turn signal. As with left and right turn signals, the front u-turn signal will be smaller than the u-turn signal in the rear.

The signal to control the u-turn inside the automobile by the driver is located at the tip of the left and right turn signal. To engage it, a button is pushed in and automatically pops out when the u-turn is completed. It is the same u-turn arrow as people are familiar with when seeing a u-turn traffic sign, thus eliminating confusion. The u-turn shaped light will solidify the intention of the driver, making it clear that the driver is u-turning.

1. What I claim as my invention is a u-turn signal at the rear left and on the front left of the automobile which is easily accessed by a button at the tip of the left and right turn signal inside the automobile; not just a left-turn arrow which confuses the person in the automobile behind into thinking the person ahead is about to accelerate and proceed with a left turn; not just a left turn arrow which confuses the person in the oncoming automobile into thinking the person u-turning is actually turning left and will be out of his or her way in much less time than when a person is u-turning. It will clearly save lives by drawing other drivers' attention to giving the driver in the automobile u-turning plenty of time to complete an 180-degree turn; not a 90-degree one.
